(19) United States
(12) Patent Application Publication
(10) Pub. No.: US 2006/0065222 A1
(43) Pub. Date: Mar. 30, 2006

(54) Disassembly aid for sealed components

(76) Inventor: Timothy L. Neal, Ortonville, MI (US)

Correspondence Address: KARL F. BARR JR.;General Motors Corporation, Legal Staff, Mail Code 482-C23-B21, P.O. Box 300, Detroit, MI, 48265-3000, US

(21) Appl. No.: 10/951,247

(22) Filed: Sep. 27, 2004

(51) Int. Cl. F01M 9/10; F02F 11/00

(52) U.S. Cl. 123/90.38; 277/591

(57) ABSTRACT

A disassembly aid for a sealed assembly is disclosed. The sealed assembly defining a fluid-containing cavity includes a first component cooperating with a second component to define the fluid containing cavity, the first and second components having cooperating sealing surfaces. A mounting opening in the first component includes a threaded jack hole with a clearance hole that is used for assembly while the threaded jack hole is configured for use during disassembly of the first component from the second component with a jack screw. The mounting opening is configured to allow a mechanical fastener to extend therethrough for securing the first component to the second component providing a compression force between the first and second components.

### BACKGROUND

The present disclosure relates to disassembly of components, and more particularly, to disassembly of components for vehicles assembled with a sealing material therebetween.

Various methods are known in the vehicular arts for retaining a fluid in a cavity defined by separable components. For example, in the art of vehicle internal combustion engines, an oil pan assembly is required to hold oil in a cavity defined by a lower oil pan assembled to an upper oil pan which is in turn attached to an engine cylinder block. The lower and upper oil pans are joined and sealed together in an assembled state with a seal therebetween. This seal is commonly a preformed gasket or an applied material such as a room-temperature vulcanizing (RTV) silicone rubber (hereinafter referred to as “RTV”).

When RTV is used to seal two components, RTV is applied in a fluid form to at least one of the two components. The two components are then assembled together before the RTV sets up. After a period of time, the RTV forms a fluid tight seal that creates an adhesive bond between the two assembled components.

In order to separate the two assembled components for service, this fluid tight seal must be broken, which proves to be difficult as a result of the adhesive bond adhering the two components together. This fluid-tight seal is often difficult to break even when prying the two assembled components apart with a leveraging tool, such as a screwdriver.

For example, disassembly of the two components sealed together with RTV may be done by prying the two assembled components apart with a screwdriver in a joint interface between the mating components after bolts maintaining the two components together are removed. Separation in this manner typically requires forcibly prying against both mating surfaces defining the joint interface. Prying at this joint interface may chip, scratch or destroy one or both of the mating surfaces, thus deteriorating the integrity of the mating surfaces for resealing. Moreover, the currently practiced disassembly method of prying with a flat bladed screwdriver necessitates caution, because the sharpness of the edges defining the flat bladed portion during such wedging and prying in the joint interface is variable and unpredictable. As such, to effect disassembly and reattachment of the two components, extra care and inspection are typically required at the prying interface to maintain the integrity of the mating surfaces in order to reseal the same.

Alternatively, it is common practice to add at least one tapped hole to one of the two components for use with a complementary threaded jack screw or bolt during disassembly of the two RTV sealed components to break the fluid tight seal. As a leading end of the bolt is threaded into an exposed opening defining the tapped hole, the leading end extends to an opposite end of the tapped hole when turned. When the leading end mates with a surface of the other component abutting the opposite end of the tapped hole, further turning of the bolt forces the two components apart as in a jack screw arrangement. However, this arrangement requires additional holes to be formed and tapped for utilization only during disassembly of the two components. Moreover, these extra holes limit the mating surface area between the two components upon which the RTV can adhere to.

Therefore, there exists a need in the art for a method and apparatus for RTV sealed components adhered to one another to be easily separated during disassembly. Further, there exists a need for a disassembly aid for RTV sealed components that eliminates a potential for harm to the integrity of the mating surfaces upon disassembly of the components, while eliminating a need to form extra holes in one of the components for use only during disassembly.

### BRIEF SUMMARY

Disclosed herein is a sealed assembly defining a fluid-containing cavity, the sealed assembly comprising: a first component cooperating with a second component to define the fluid containing cavity, the first and second components having cooperating sealing surfaces; and a mounting opening in the first component, the mounting opening including a threaded jack hole and a clearance hole, the threaded jack hole and clearance hole configured for use in assembly of the first and second components, the threaded jack hole configured for use during disassembly of the first component from the second component, the mounting opening configured to allow a mechanical fastener to extend therethrough for securing the first component to the second component, the fastener when engaged providing a compression force between the first and second components.

Also disclosed is an engine cover assembly defining a fluid-containing cavity, the assembly comprising: an engine component including a sealing surface defining an edge of the cavity; a cover including a fluid-containing wall surrounded by a peripheral edge and having a sealing surface opposing the sealing surface of the engine component, and a plurality of mounting openings in the wall, at least one mounting opening of the plurality of mounting openings integrating a threaded jack hole with a clearance hole used for assembly, the threaded jack hole configured for use during disassembly of the cover from the engine component; and mechanical fasteners extending through the openings for securing the cover to a mating edge of the engine component, the fasteners when engaged providing a compression force on the sealing surfaces of the cover and engine component for engagement with a compliant sealing material disposed between the sealing surfaces defining a gap therebetween.

In yet another embodiment, a method for a disassembly aid in a first component cooperating with a second component defining a fluid containing cavity, the first and second components having cooperating sealing surfaces is disclosed. The method includes: configuring a mounting opening in the first component, the mounting opening configured to allow a mechanical fastener to extend therethrough for securing the first component to the second component, the fastener when engaged providing a compression force between the first and second components; and configuring a threaded jack hole and a clearance hole in the mounting opening for use in assembly of the first and second components, wherein the threaded jack hole is configured for use during disassembly of the first component from the second component.

The above-described and other features are exemplified by the following figures and detailed description.

### BRIEF DESCRIPTION OF THE DRAWINGS

Referring now to the figures, which are meant to be exemplary embodiments, and wherein like elements are numbered alike:

FIG. 1 is an exploded perspective view of an engine assembly having an engine cylinder block and oil pan assembly in accordance with an exemplary embodiment;

FIG. 2 is an enlarged perspective view illustrating a lower oil pan and an upper oil pan of the oil pan assembly of FIG. 1 shown upside down;

FIG. 3 is a partial cross section view of the upper and lower oil pans of FIG. 2 assembled with an assembly bolt in accordance with an exemplary embodiment;

FIG. 4 is a view of the assembled oils pans of FIG. 3 with the assembly bolt removed and a jack screw threaded into the lower oil pan assembly for prying apart the oil pan assembly in accordance with an exemplary embodiment;

FIG. 5 is an enlarged view of FIG. 4 illustrating integration of a jack hole with a clearance hole in the lower oil pan in accordance with an exemplary embodiment;

FIG. 6 is a partial cross section view of two components assembled with an assembly bolt extending through both components and threadably engaged with a nut in accordance with an alternative exemplary embodiment; and

FIG. 7 is a view of the assembled components of FIG. 6 with the assembly bolt removed and a jack screw threaded into one of the two components having an integrated jack hole with a clearance hole for prying apart the two components in accordance with an alternative exemplary embodiment.

### DETAILED DESCRIPTION OF THE PREFERRED EMBODIMENT

The present disclosure provides a disassembly aid for components bolted together having a sealing material on complementary mating sealing surfaces that creates a seal and an adhesive bond between the components. The disassembly aid integrates a threaded jack hole with a clearance hole for use with a bolt for mating the components together. The threaded jack hole is used with a jack screw during disassembly, thus the jack screw used for disassembly is configured with a larger diameter than a diameter of the bolt used for assembly. This integration reduces a machining requirement to add one or more separately tapped holes in one of the components for the sole purpose of being used with a jack screw during disassembly to break the bond created by the cured sealing material. Furthermore, such a reduction in separately tapped holes increases a surface area of the interfacing sealing surfaces available for sealably mating the components together.

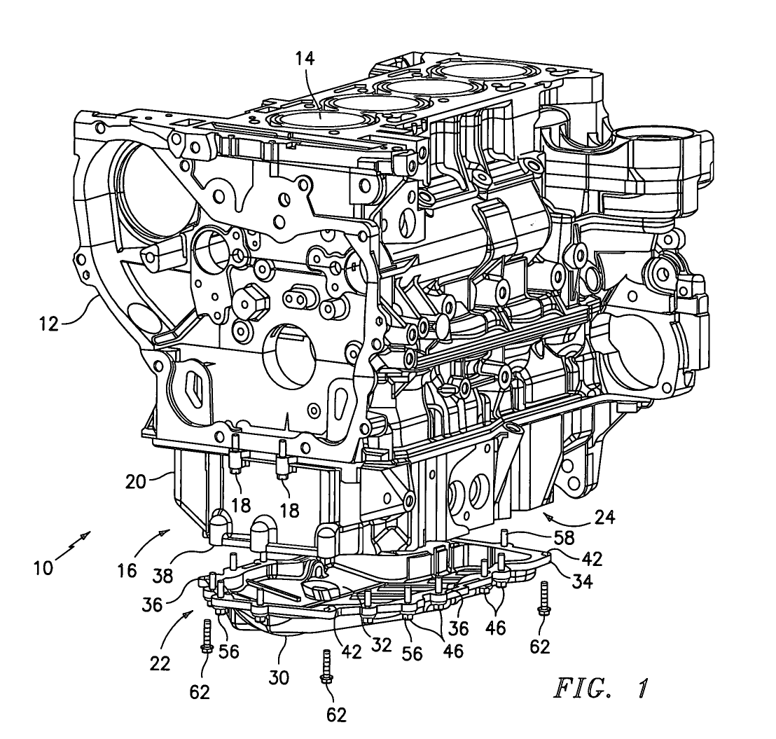

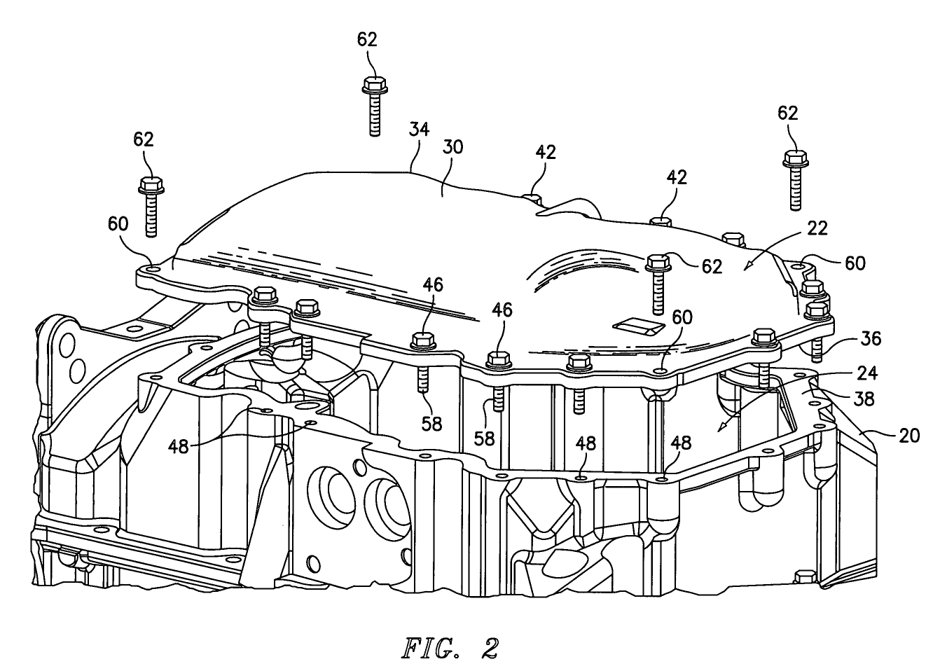

Referring to the drawings in detail, a portion of an engine assembly 10 is illustrated including an engine cylinder block 12 having at least one engine cylinder 14 (four cylinders 14 shown). Block 12 includes an oil pan assembly 16 bolted to block 12 via bolts 18. Oil pan assembly 16 includes an upper oil pan 20 having a sealed cover assembly 22 covering a cavity 24 defined by upper oil pan assembly 20, as best seen in FIG. 2. The open bottom as illustrated in FIG. 1 (or open top as illustrated in FIG. 2) is closed by sealed cover assembly 22 defining internal fluid containing cavity 24 that extends into cylinder block 12. Internal fluid containing cavity 24 is configured to retain oil therein for use in lubricating components associated with engine assembly 10.

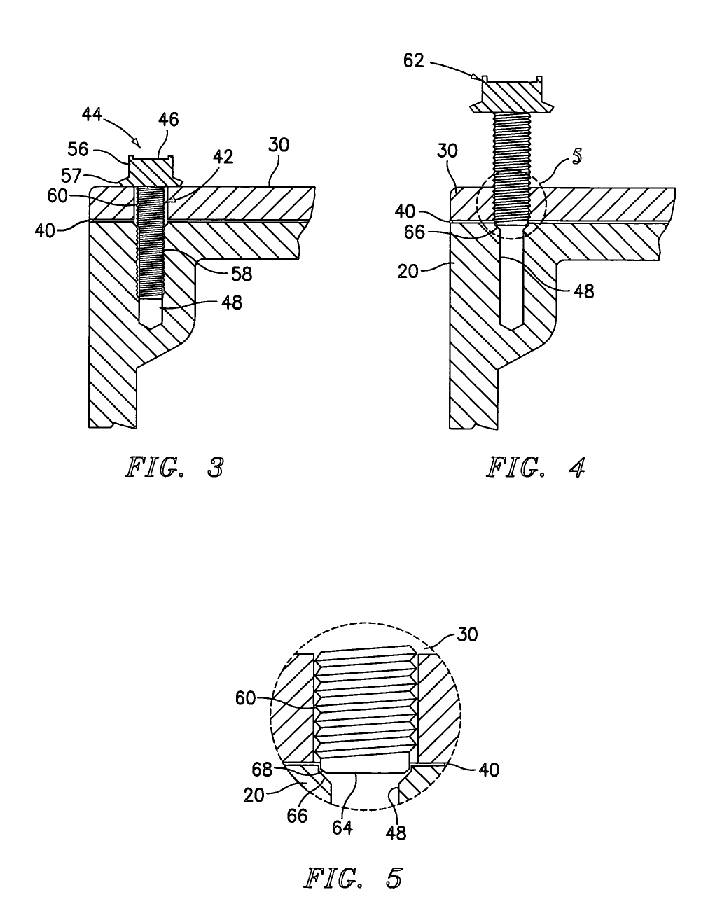

The sealed cover assembly 22 includes a cover or lower oil pan 30 having a fluid-containing wall 32 surrounded by a peripheral edge 34 with an inwardly facing sealing surface 36 aligned with an outwardly facing sealing surface 38 of the upper oil pan 20. A suitable sealing material, such as a RTV sealing material 40, is applied on at least one of sealing surfaces 36 and 38 in fluid form and cures at room temperature after installation of the cover 30 (see FIGS. 3-5).

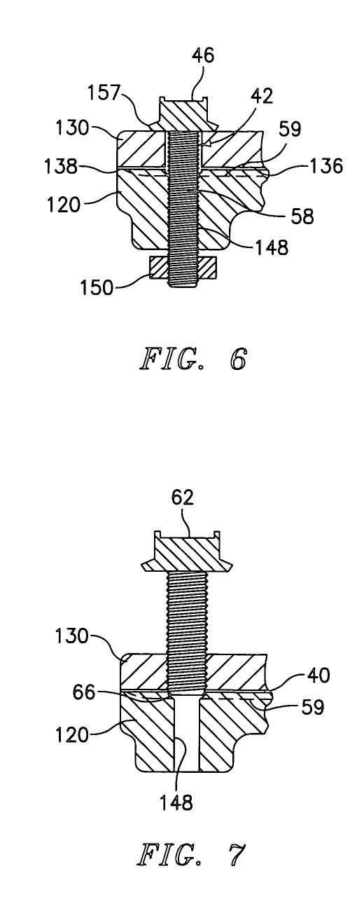

The cover assembly 22 includes a plurality of mounting openings 42, in each of which is retained a mounting fastener 46 including a bolt 46, for example, extending through the opening 42 and threadably received in a corresponding threaded opening 48 in upper oil pan 20. It is envisioned that threaded opening 48 may alternatively be a through hole in which bolt 46 extends therethrough to threadably receive a nut (shown in FIG. 6) at an opposite end.

Referring to FIGS. 1-3, the bolt 46 includes a head end 56 incorporating a flange 57 that engages an exterior surface of cover 30 defining each opening 42. Head end 56 may include a slot (not shown) or other pattern for a complementary configured screwdriver and includes a polygonal shape for engagement with a complementary configured wrench or socket. The main body of the bolt 46 slidably extends through the opening 42 as a clearance hole with a threaded end 58 protruding beyond wall 32. A bolt 46 is installed within each of the cover openings 42 and is retained within its respective opening 48 by any suitable means to form the sealed cover assembly 22 adapted for assembly onto the engine cylinder block 12.

For mounting of the cover assembly 22 to upper oil pan 20, with reference to FIG. 3, cooperating threaded openings 48 are provided in the upper oil pan 20 into which the ends 58 of the bolts are threaded to mount the cover 30 onto the upper oil pan 20. Prior to the assembly step, a bead of RTV sealing material 40 in fluid form is applied either to the sealing surface 36 of the cover 30 or to the opposing sealing surface 38 of the upper oil pan 20. The cover 30 is then positioned opposite the upper oil pan sealing surface 38. The bolts 46 are then slidably extended through openings 42 and threaded into their corresponding openings 48 in the upper oil pan 20 and tightened down until the bolt head flanges 57 engage an exterior peripheral surface defining each opening 42 in cover 30.

An interface between upper and lower oil pans 20 and 30, respectively, is filled by the fluid RTV sealing material 40, which becomes self-vulcanized or cured at room temperature in a short period of time after assembly. At least one of the sealing surfaces 36, 38 of the cover 30 and upper oil pan 20 optionally includes a groove 59 (see FIGS. 6 and 7) into which some of the RTV sealing material 40 is displaced. When the RTV sealing material 40 is cured, interaction with the groove 59 prevents the sealing material 40 from being easily dislodged from the gap or interface between the sealing surfaces 36, 38 and maintains the sealing material 40 in position under all operating conditions of the engine.

The sealing provided by the RTV sealing material 40 is able to fill in variations in a gap between the sealing surfaces 36 and 38, as well as surface irregularities and thus provides a dependable fluid containing seal between the cover 30 and upper oil pan 20. In addition, the sealing provided by the RTV sealing material 40 creates an adhesive bond therebetween that is difficult to break during disassembly.

In accordance with the present disclosure, at least one of the openings 42 includes a threaded jack hole 60 integrated with opening 42 used as a clearance hole during assembly. In an exemplary embodiment, a plurality of thread jack holes 60 are integrated with a corresponding opening 42 located at strategic locations in any given bolt pattern. For example, the strategic locations include opposing corners of the bolt pattern corresponding to corners defining the cover 30. In FIGS. 1 and 2, four locations are illustrated corresponding with four corners substantially defining cover 30. However, any number of locations and patterns are contemplated suitable to the desired end purpose. More specifically, at least some of the mounting openings 42 located at strategic locations of the bolt pattern include an integrated threaded jack hole 60 used for disassembly with a jack screw 62 and used as a clearance hole during assembly with bolt 46.

Referring now to FIG. 4, a portion of cover 30 and upper oil pan 20 are illustrated with bolt 46 removed and shown with a jack screw or bolt 62 threadably received in threaded jack hole 60. In this manner, after bolts 46 are removed from respective openings 42, cover 30 may be removed from upper oil pan 20, however, an adhesive seal created by sealing material. 40 must first be broken to separate the components. In the embodiment illustrated in FIGS. 3 and 4, for example, jack screw 62 is a M8 bolt while bolt 46 is a M6 bolt used for assembly, however, other suitable bolt configurations are contemplated to be used that are suitable to the desired end purpose and application.

Referring now to FIGS. 4 and 5, it will be recognized that when bolt 62 is threaded into jack hole 60 having a M8×1.25 tapped thread, a leading end 64 corresponding with a threaded end of bolt 62 includes a larger diameter than a diameter of opening 48 configured in upper oil pan 20. In the embodiment shown, opening 48 has a diameter corresponding to a M6×1.00 tapped thread to threadably receive bolt 42 during assembly. When the leading end 64 of bolt 62 abuts the smaller diameter opening 48, any further turning of bolt 62 begins to pry surface 36 of cover 30 from surface 38 of upper oil pan 20 to break the adhesive seal therebetween as a result of the cured sealing material 40. In an exemplary embodiment shown in FIGS. 4 and 5, opening 48 includes a countersunk portion generally indicated at 66 to receive a complementary configured taper 68 defining leading end 64. In this manner, it will be recognized by one skilled in the pertinent art that taper 68 is received in countersunk portion 66 to ensure concentric or coaxial rotation therebetween and to ensure that the integrity of surface 38 is maintained. [0031] Referring now to FIGS. 6 and 7, two assembled components with a sealing material 40 therebetween are illustrated in accordance with an alternative embodiment. A cover 130 is assembled to a mating component 120 with reference to FIG. 6 where a clearance hole opening 148 is provided in the mating component 120 into which the ends 58 of the bolts extend through component 120 and threaded into a nut 150 to securely mount the cover 130 with mating component 120. Prior to the assembly step, a bead of RTV sealing material 40 in fluid form is applied either to the sealing surface 136 of the cover 130 or to the opposing sealing surface 138 of the mating component 120. The cover 130 is then positioned opposite the sealing surface 138 of mating component 120. Bolt 46 is then slidably extended through openings 42 and 148 and then threaded into a corresponding nut 150. Either or both nut 150 and bolt 46 are then tightened until the bolt head flange 157 engages an exterior peripheral surface defining each opening 42 in cover 130 and nut 150 abuts an exterior peripheral surface defining each opening 148 in cover mating component 120.

Referring now to FIG. 7, a portion of cover 130 and mating component 120 are illustrated with bolt 46 removed and shown with jack screw or bolt 62 threadably received in threaded jack hole 60. In this manner, after each bolt 46 is first loosened with respect to nut 150 and then removed from respective openings 42 and 148, cover 130 may be removed from mating component 120, however, an adhesive seal created by sealing material 40 must first be broken to separate the components using bolt 62, as described above with reference to FIGS. 4 and 5.

While the exemplary cover assembly design illustrated involves a number of specific design considerations, the integrated jack hole and clearance hole concept can be utilized with other cover designs to assemble a cover of any type using a sealing material with an associated mating component on which it is mounted, while aiding disassembly thereof using a jack screw in a threaded clearance hole that is also used for assembly. If desired, the jack screw may be an assembly bolt that is removed from the cover at a different hole location having a threaded diameter larger than a threaded diameter of a smaller diameter bolt threaded into the mating component. However, using a same size threaded hole in the mating component for each mounting location is preferred for ease of manufacture, assembly and parts retention. If necessary, the mating component may include a clearance hole in which a bolt slidably extends therethrough to threadably engage with a nut in place of a threaded hole in the mating component to receive the bolt. In either case, the other component or cover integrates a tapped hole as a clearance hole for mating the two components, while using the tapped hole with a larger diameter bolt as a threaded jack hole for disassembly. In both cases, machining requirements are reduced because separately tapped holes for use only with the jack screws are not required in remote or separate locations.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

1. A sealed assembly defining a fluid-containing cavity, the sealed assembly comprising:
a first component cooperating with a second component to define the fluid containing cavity, the first and second components having cooperating sealing surfaces; and
a mounting opening in the first component, the mounting opening including a threaded jack hole and a clearance hole, the threaded jack hole and clearance hole configured for use in assembly of the first and second components, the threaded jack hole configured for use during disassembly of the first component from the second component, the mounting opening configured to allow a mechanical fastener to extend therethrough for securing the first component to the second component, the fastener when engaged providing a compression force between the first and second components.

2. The sealed assembly of claim 1 including a compliant sealing material disposed between the cooperating sealing surfaces of the first and second components.

3. The sealed assembly of claim 2 including a settable sealing material engaging the cooperating sealing surfaces for closing a gap between the cooperating sealing surfaces and preventing the escape of fluid from the cavity defined by the first and second components.

4. The sealed assembly of claim 3 wherein the sealing material is an RTV compound.

5. The sealed assembly of claim 3 wherein at least one of the sealing surfaces includes a linear groove for receiving the sealing material prior to setting of the material after installation of the first component wit the second component.

6. The sealed assembly of claim 3 wherein the compliant sealing material is a low compression seal.

7. The sealed assembly of claim 1 further comprising:
a jack screw having a threaded diameter corresponding to the threaded jack hole of the mounting opening, the jack screw configured to threadably engage the jack hole and jack the first component away from the second component upon engagement of a leading end of the jack screw with the second component.

8. The sealed assembly of claim 7, wherein the leading end of the jack screw engages a corresponding opening configured in the second component, the opening having a diameter smaller than a diameter of the jack screw.

9. The sealed assembly of claim 8, wherein the leading end of the jack screw engages a counter sunk portion of the corresponding opening in the second component.

10. The sealed assembly of claim 8, wherein the opening configured in the second component is one of threaded to threadably receive the mechanical fastener and a through hole allowing for the mechanical fastener to extend therethrough and threadably receive a complementary threaded nut.

11. The sealed assembly of claim 1, wherein the mounting opening is one of a plurality of mounting openings, one or more of the plurality of mounting openings each including the threaded jack hole with the clearance hole used for assembly and the threaded jack hole used for disassembly and located at strategic locations of a corresponding bolt pattern.

12. The sealed assembly of claim 11, wherein the strategic locations include opposing corners of the bolt pattern corresponding to corners defining the second component.

13. The sealed assembly of claim 1, wherein the first component includes a lower oil pan and the second component includes an upper oil pan of an oil pan assembly mounted to an engine cylinder block.

14. An engine cover assembly defining a fluid-containing cavity, the assembly comprising:
an engine component including a sealing surface defining an edge of the cavity;
a cover including a fluid-containing wall surrounded by a peripheral edge and having a sealing surface opposing the sealing surface of the engine component, and a plurality of mounting openings in the wall, at least one mounting opening of the plurality of mounting openings integrating a threaded jack hole with a clearance hole used for assembly, the threaded jack hole configured for use during disassembly of the cover from the engine component; and
mechanical fasteners extending through the openings for securing the cover to a mating edge of the engine component, the fasteners when engaged providing a compression force on the sealing surfaces of the cover and engine component for engagement with a compliant sealing material disposed between the sealing surfaces defining a gap therebetween.

15. The engine cover assembly as in claim 14 further comprising:
a jack screw having a threaded diameter corresponding to the threaded jack hole of the at least one mounting opening, the jack screw configured to threadably engage the jack hole and jack the cover away from the engine component upon engagement of a leading end of the jack screw with the engine component.

16. A method for a disassembly aid in a first component cooperating with a second component in a sealed assembly defining a fluid containing cavity, the first and second components having cooperating sealing surfaces, the method comprising:
configuring a mounting opening in the first component, the mounting opening configured to allow a mechanical fastener to extend therethrough for securing the first component to the second component, the fastener when engaged providing a compression force between the first and second components; and
configuring a threaded jack hole and a clearance hole in the mounting opening for use in assembly of the first and second components, wherein the threaded jack hole is configured for use during disassembly of the first component from the second component.

17. The method of claim 16 further comprising:
configuring a mounting aperture in a second component, the mounting aperture aligned with the mounting opening of the first component, the mounting aperture having a diameter to receive a mechanical fastener therethrough while preventing a jack screw therethrough;
removing the mechanical fastener extending through the mounting opening for securing the first component to the second component, the fastener when engaged providing a compression force on respective cooperating sealing surfaces of the first and second components; and
engaging the jack screw having a threaded diameter corresponding to the threaded jack hole of the mounting opening; and
jacking the first component away from the second component upon engagement of a leading end of the jack screw with the second component.

18. The method of claim 16, wherein a compliant sealing material is disposed between the cooperating sealing surfaces of the first and second components.

19. The method of claim 16, wherein a settable sealing material engages the cooperating sealing surfaces for closing a gap between the sealing surfaces and preventing the escape of fluid from a cavity defined by the first and second components.

20. The method of claim 19, wherein the sealing material is an RTV compound.

21. The method of claim 17, wherein the leading end of the jack screw engages an opening defining the mounting aperture configured in the second component, the opening defining the mounting aperture having a diameter smaller than a diameter of the jack screw.

22. The method of claim 21, wherein the leading end of the jack screw engages a counter sunk portion of the opening in the second component.

23. The method of claim 21, wherein the opening configured in the second component is one of threaded to threadably receive the mechanical fastener and a through hole for allowing the mechanical fastener to extend therethrough and threadably receive a complementary threaded nut.

24. The method of claim 16, further comprising:
locating two or more of the at least one mounting opening of the plurality of mounting openings each including a threaded jack hole with a clearance hole used for assembly at strategic locations of a corresponding bolt pattern.

25. The method of claim 24, wherein the strategic locations include opposing corners of the bolt pattern corresponding to corners defining the first component.

26. The method of claim 16, wherein the first component includes a tower oil pan and the second component includes an upper oil pan of an oil pan assembly operably mounted to an engine cylinder block.
